(19) United States
(12) Patent Application Publication
(10) Pub. No.: US 2024/0077315 A1
(43) Pub. Date: Mar. 7, 2024

(54) ALIGNMENT OF A COORDINATE FRAME WITH A BORESIGHT AXIS OF AN OPTICAL TRACKING DEVICE

(71) Applicants: DANIEL A. TAZARTES, West Hills, CA (US); NEAL JOSEPH DAHLEN, Marshfield, MA (US)

(72) Inventors: DANIEL A. TAZARTES, West Hills, CA (US); NEAL JOSEPH DAHLEN, Marshfield, MA (US)

(73) Assignee: NORTHROP GRUMMAN SYSTEMS CORPORATION, FALLS CHURCH, VA (US)

(21) Appl. No.: 17/901,255

(22) Filed: Sep. 1, 2022

(51) Int. Cl. G01C 21/16; G01B 11/27

(52) U.S. Cl. CPC G01C 21/1656; G01B 11/27

(57) ABSTRACT

One example includes a navigation system. The navigation system includes an inertial navigation system (INS) that is configured to provide a coordinate frame corresponding to an inertial reference of the INS relative to a geodetic coordinate system. The coordinate frame includes a reference axis that defines a reference orientation of the INS. The system also includes an optical tracking device configured to obtain a reference image to determine an orientation of a boresight axis of the optical tracking device. The system further includes an alignment controller configured to compare the reference axis based on the coordinate frame and the boresight axis based on the reference image to determine an angular misalignment between the reference axis and the boresight axis, and to adjust the reference orientation to align the reference axis to the boresight axis based on the determined angular misalignment.

### TECHNICAL FIELD

This description relates generally to sensor systems, and more particularly to alignment of a coordinate frame with a boresight axis of an optical tracking device.

### BACKGROUND

Navigation systems can be implemented for a variety of purposes, and can be incorporated on a variety of different types of vehicles or other movable platforms to provide information about directional heading and orientation based on inertial sensors (e.g., gyroscopes, accelerometers, magnetometers, etc.). Some navigation systems implement optical tracking devices (e.g., star trackers) that implement a telescope or other optical device to provide stellar/celestial observations to aid in navigation. The telescope and an associated inertial navigation system (INS) can be mounted on a common structure. As an example, the entire structure could be mounted on one or more gimbals (e.g., azimuth and elevation) to allow for pointing to various stars and objects in the sky.

The telescope data can provide line-of-sight information as to the orientation of the system relative to the stars and/or satellites with known orbits that are observable. In turn, the line-of-sight information can be used to correct navigation system errors, such as attitude or position errors. However, if the angular alignment of the co-mounted INS and telescope assemblies is not perfect, then alignment errors may be erroneously misinterpreted as errors in attitude or position of the movable platform. Further, if the INS attitude is used to point the telescope, then errors in pointing can occur, which can render it more difficult and time-consuming to acquire and make the stellar/celestial observations.

### SUMMARY

One example includes a navigation system. The navigation system includes an inertial navigation system (INS) that is configured to provide a coordinate frame corresponding to an inertial reference of the INS relative to a geodetic coordinate system. The coordinate frame includes a reference axis having a reference orientation relative to physical axes of the INS. The system also includes an optical tracking device configured to obtain a reference image to determine an orientation of a boresight axis of the optical tracking device. The system further includes an alignment controller configured to compare the reference axis based on the coordinate frame and the boresight axis based on the reference image to determine a three-dimensional angular misalignment between the reference axis and the boresight axis, and to adjust the reference orientation to provide an adjusted reference axis that is aligned with the boresight axis based on the determined three-dimensional angular misalignment.

Another example described herein includes a method for aligning a boresight axis of an optical tracking device with a coordinate frame of an INS. The method includes obtaining a coordinate frame corresponding to an inertial reference of the INS relative to a geodetic coordinate system. The coordinate frame comprising a reference axis having a reference orientation relative to physical axes of the INS. The method also includes obtaining a reference image via the optical tracking device to determine an orientation of a boresight axis of the optical tracking device. The method also includes implementing an alignment algorithm to calculate a three-dimensional misalignment angle between the reference axis and the boresight axis based on the coordinate frame and the reference image. The method further includes adjusting the reference orientation in the memory to provide an adjusted reference axis to the boresight axis by the three-dimensional misalignment angle.

Another example described herein includes a navigation system. The navigation system includes an inertial navigation system (INS) that is configured to provide a coordinate frame corresponding to an inertial reference of the INS relative to a geodetic coordinate system. The coordinate frame includes a reference axis having a reference orientation relative to physical axes of the INS. The system also includes an optical tracking device configured to obtain a reference image to determine an orientation of a boresight axis of the optical tracking device. The system further includes an alignment controller configured to compare the reference axis based on the coordinate frame and the boresight axis based on the reference image to calculate a three-dimensional misalignment angle between the reference axis and the boresight axis. The alignment controller can further be configured to implement vector matrix calculations to convert the three-dimensional misalignment angle to a coordinate frame transformation and to adjust the reference orientation by the three-dimensional misalignment angle to provide an adjusted reference axis that is aligned with the boresight axis.

### BRIEF DESCRIPTION OF THE DRAWINGS

FIG. 1 is an example block diagram of a navigation system.

FIG. 2 is an example of a navigation system.

FIG. 3 is an example of a method for aligning an optical axis with an inertial navigation system (INS) coordinate frame.

### DETAILED DESCRIPTION

This description relates generally to sensor systems, and more particularly to alignment of a coordinate frame with a boresight axis of an optical tracking device. A navigation system can include an inertial navigation system (INS) and an optical tracking device. The INS can be configured as an assembly that includes a variety of inertial sensors (e.g., gyroscopes, accelerometers, magnetometers, etc.) that can provide a coordinate frame that is an inertial reference corresponding to an orientation of a movable platform (e.g., vehicle) on which the INS is included. As described herein, the coordinate frame corresponds to an inertial orientation of the movable platform in three-dimensional space that is defined by and updated by an output of at least one inertial sensor in response to motion (e.g., roll, pitch, and yaw) of the movable platform. Therefore, the coordinate frame provided by the INS can demonstrate an orientation of the movable platform relative to a geodetic coordinate system (e.g., the fixed Earth geodetic frame that includes North, East, and Down). For example, the INS can determine an orientation relative to the geodetic coordinate system using known techniques such as gyrocompass alignment, such as to simultaneously observe the direction of the gravity vector and the Earth rotation rate vector, or equivalent methods.

The coordinate frame can include a reference axis that has a reference orientation relative to physical axes of the INS. As described herein, the reference axis can correspond to a virtual axis that is referenced to the coordinate frame of the INS, such as by a three-dimensional virtual angle with respect to physical orthogonal axes from which the coordinate frame of the INS is defined. As also described herein, the reference orientation can correspond to the three-dimensional rotation angle between the reference axis and one of the physical orthogonal axes from which the coordinate frame of the INS is defined. As an example, the reference orientation can correspond to a three-dimensional angular offset between the reference axis and a forward axis of the INS. Therefore, at any given time, the INS can identify a relationship between the coordinate frame and the reference axis based on the reference orientation. As an example, the INS can include a memory (e.g., a nonvolatile memory) that is configured to store the reference orientation.

In addition, the navigation system can include an optical tracking device (e.g., a telescope, star tracker, camera, laser, or other optical device) that is configured to obtain reference images to determine an orientation of a boresight axis of the optical tracking device. The reference image can be a celestial image (e.g., star tracking), or can correspond to a known fixed feature (e.g., topographical feature). As an example, the reference images can be compared with a position reference database, such as configured as a lookup table or a catalog that is configured to provide known positions of reference features (e.g., celestial bodies) at specific times and from specific locations. Therefore, during normal operation of the navigation system, the orientation of the INS can be refined based on the obtained reference images. As an example, during normal operation of the navigation system, the reference axis of the INS and the boresight axis of the optical tracking device can be approximately aligned.

Certain conditions can cause an angular misalignment (e.g., in three-dimensions) between the boresight axis and the reference axis. As an example, the angular misalignment can occur during manufacture of the navigation system. As another example, kinetic shock can cause a physical misalignment of the optical tracking device relative to the INS, thereby causing the angular misalignment between the boresight axis and the reference axis. Such angular misalignment can result in errors in attitude or position of the movable platform. Further, if the INS attitude is used to point the optical tracking device to obtain the reference images, then the angular misalignment can result in pointing errors. Such pointing errors can render it more difficult and time-consuming to acquire the reference images.

To correct angular misalignment between the boresight axis and the reference axis of the INS, the navigation system can include an alignment controller that is configured to compare the reference axis, as provided by the coordinate frame of the INS, and the boresight axis, as provided by the reference image, to calculate a misalignment angle in three-dimensional space. The alignment controller can implement vector matrix calculations to convert the misalignment angle to a coordinate frame transformation and to adjust the reference orientation by the misalignment angle to provide an adjusted reference axis that is aligned with the boresight axis. Therefore, by aligning the reference axis to the boresight axis, the navigation system can be sufficiently calibrated to provide more effective inertial measurements in providing an orientation of an associated movable platform.

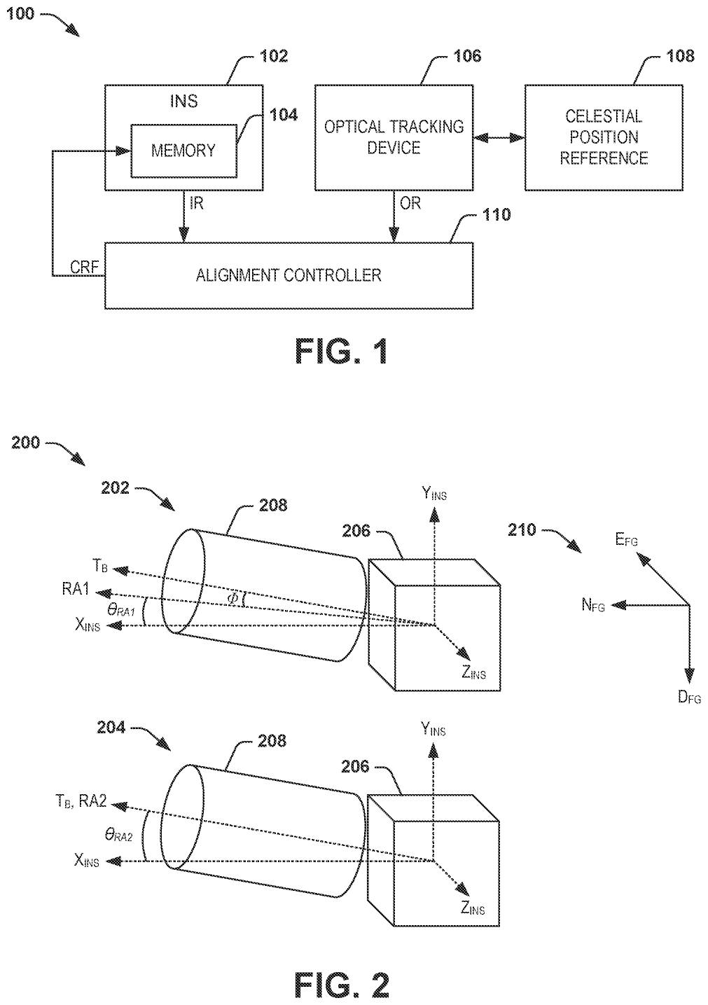

FIG. 1 is an example block diagram of a navigation system 100. The navigation system 100 can be implemented on a movable platform, such as any of a variety of vehicles (e.g., an aircraft or a spacecraft). The navigation system 100 can be implemented to determine an orientation of the movable platform in three-dimensional space, such as with respect to a geodetic coordinate system (e.g., North, East, and Down).

The navigation system 100 includes an inertial navigation system (INS) 102. The INS 102 can be configured as a combination hardware and software tool that includes inertial sensors and one or more processors to provide inertial data associated with the inertial sensors. As an example, the INS 102 can include one or more gyroscopes, magnetometers, and/or accelerometers that can provide inertial data, such that the INS 102 can provide the inertial data to controls associated with the movable platform. The INS 102 can therefore provide a coordinate frame, demonstrated in the example of FIG. 1 as a signal IR, corresponding to an orientation of the movable platform on which the INS 102 is included relative to the geodetic coordinate system.

The coordinate frame can include a reference axis that has a defined reference orientation relative to physical axes of the INS 102. Therefore, at any given time, the INS can identify a relationship between the coordinate frame and the reference axis based on the reference orientation. In the example of FIG. 1, the INS 102 includes a memory 104. The memory 104 can be a nonvolatile memory that is configured to store the reference orientation of the reference axis, such as the rotation angle between the reference axis and one or more of the physical axes of the coordinate frame of the INS 102. As an example, the reference orientation can correspond to a three-dimensional angular offset between the reference axis and a forward axis of the INS 102, the forward axis corresponding to an axis that is intended to designate a forward direction of the INS 102. The memory 104 can thus facilitate access of the reference orientation to provide the reference axis upon initialization (e.g., power-up) of the movable platform.

The navigation system 100 also includes an optical tracking device 106. The optical tracking device 106 can be arranged, for example, as a telescope, star tracker, camera, laser, or other optical device that is configured to obtain one or more reference images to determine an orientation of a boresight axis of the optical tracking device 106. In the example of FIG. 1, the navigation system 100 includes a position reference database 108 that is configured to provide known positions of reference structures, such as celestial bodies, at specific times and from specific locations. As an example, the position reference database 108 can be configured as a lookup table or a catalog that is able to provide or calculate the known positions of reference structures at specific times and from specific locations. As a first example, the optical tracking device 106 can obtain a single reference image for comparison with the position reference database 108. As another example, the optical tracking device 106 can obtain multiple reference images for comparison with the position reference database 108, such as successively or over a duration of time. The multiple reference images can correspond to multiple reference images of the same reference structure, such as from different orientations of the boresight axis or approximately the same orientation of the boresight axis, or can be multiple reference images of different reference structures (e.g., different celestial bodies).

In the example of FIG. 1, based on the obtained reference image relative to the data provided by the position reference database 108, the optical tracking device 106 provides a boresight orientation, demonstrated in the example of FIG. 1 as a signal OR, corresponding to an orientation of the boresight axis. The boresight orientation OR can correspond to the orientation of the boresight axis based on a single reference image, or based on the multiple reference images. As an example, the optical tracking device 106 can implement an aggregation algorithm (e.g., averaging) to determine the boresight orientation OR based on the multiple reference images. Therefore, the boresight orientation OR can be determined based on an aggregation of the multiple reference images.

As an example, during normal operation of the navigation system 100, the reference axis of the INS 102 and the boresight axis of the optical tracking device 106 can be approximately aligned. Therefore, during normal operation of the navigation system 100, the orientation of the INS 102 can be refined based on the obtained reference images OR by the optical tracking device 106. However, certain conditions can cause an angular misalignment between the boresight axis of the optical tracking device 106 and the reference axis of the INS 102. As an example, the angular misalignment can occur during manufacture of the navigation system 100. As another example, kinetic shock can cause a physical misalignment of the optical tracking device 106 relative to the INS 102, thereby causing the angular misalignment between the boresight axis and the reference axis. Because the reference axis is referenced to the coordinate frame (e.g., by the reference orientation), such angular misalignment between the boresight axis and the reference axis can result in errors in attitude or position of the movable platform. Further, if the attitude of the INS 102 is used to point the optical tracking device 106 to obtain the reference images, then the angular misalignment can result in pointing errors. Such pointing errors can render it more difficult and time-consuming to acquire the reference images.

In the example of FIG. 1, the navigation system 100 includes an alignment controller 110 that is configured to estimate and correct a three-dimensional angular misalignment between the boresight axis of the optical tracking device 106 and the reference axis of the INS 102. The alignment controller 110 is configured to receive the coordinate frame IR corresponding to the orientation of the INS 102 and the boresight orientation OR corresponding to the boresight axis of the optical tracking device 106. The alignment controller 110 can thus compare the orientation of the INS 102, as provided by the coordinate frame IR, and the boresight orientation OR of the boresight axis of the optical tracking device 106 to provide an adjusted reference axis that is aligned with the boresight axis, thereby aligning the reference axis to the boresight axis. As described herein, the phrase “aligning the reference axis to the boresight axis” describes changing the virtual reference orientation, as stored in the memory 104, to align the virtual reference axis of the coordinate frame to be aligned to the physical boresight axis of the optical tracking device 106.

In the example of FIG. 1, the alignment controller 110 is demonstrated as providing a signal CRF to the memory 104 of the INS 102. For example, the signal CRF can correspond to correction factors to the reference orientation saved in the memory 104, or can correspond to an entirely updated reference orientation to be saved in the memory 104, thereby replacing the previously saved reference orientation. In either example, the updated reference orientation can provide a three-dimensional angular shift of the alignment of the virtual reference axis of the INS 102 to the physical boresight axis of the optical tracking device 106 to provide an adjusted reference axis. Accordingly, by aligning the reference axis to the boresight axis, the navigation system can be sufficiently calibrated to provide more effective inertial measurements in providing an orientation of the associated movable platform.

As an example, the alignment controller 110 can calculate the three-dimensional angular misalignment between the boresight axis of the optical tracking device 106 and the reference axis of the INS 102, and thus providing the signal CRF, based on providing the boresight orientation OR from a single reference image relative to the coordinate frame IR at a respective single instance. As another example, the angular misalignment between the boresight axis of the optical tracking device 106 and the reference axis of the INS 102, and thus the signal CRF, can be based on multiple boresight orientations OR relative to respective instances of the coordinate frame IR. For example, the optical tracking device 106 can obtain multiple reference images for comparison with the position reference database 108, such as successively or over a duration of time, with the multiple reference images corresponding to multiple reference images of the same reference structure from different orientations or the same orientation of the boresight axis, or can be multiple reference images of different reference structures (e.g., different celestial bodies), with each reference image providing the boresight orientation OR relative to a different instance of the coordinate frame IR. Therefore, the calculation of the angular misalignment between the boresight axis of the optical tracking device 106 and the reference axis of the INS 102, and thus the calculation of the correction factors of the signal CRF, can be based on an aggregation of the different reference images relative to the instances of the coordinate frame IR of the INS 102.

FIG. 2 is an example diagram 200 of a navigation system. The navigation system can correspond to a portion of the navigation system 100 described above in the example of FIG. 1. Therefore, reference is to be made to the example of FIG. 1 in the following description of the example of FIG. 2. In the example of FIG. 2, the navigation system is demonstrated in a first view 202 corresponding to a time prior to calibration and a second view 204 subsequent to calibration.

The navigation system 200 includes an INS 206 and an optical tracking device 208, demonstrated in respective three-dimensional representations. Similar to as described above, the INS 206 can be configured as a combination hardware and software tool that includes inertial sensors and one or more processors to provide inertial data associated with the inertial sensors. The INS 206 can therefore provide the coordinate frame corresponding to an inertial orientation of the INS 206, and thus an orientation of a movable platform in which the INS 206 is included. In the example of FIG. 2, the INS 206 includes physical axes from which the coordinate frame can be provided relative to geodetic coordinates, demonstrated at 210. The geodetic coordinates 210 demonstrated as the Earth geodetic frame, thus including a North axis N_{FG}, an East axis E_{FG}, and a down axis D_{FG} that are orthogonal with respect to each other. The physical axes include a first axis X_{INS}, a second axis Y_{INS}, and a third axis Z_{INS} that are orthogonal with respect to each other. Therefore, the coordinate frame of the INS 206 can be defined based on an orientation of the physical axes relative to the geodetic coordinates 210, such as updated based on the output(s) of the inertial sensor(s).

The optical tracking device 208 can be arranged, for example, as a telescope, star tracker, camera, laser, or other optical device that is configured to obtain one or more reference images to determine an orientation of a boresight axis of the optical tracking device 208. In the example of FIG. 2, the boresight axis is demonstrated as an axis T_{B} that is angularly offset from the axis X_{INS} of the INS 206. As an example, the reference images captured by the optical tracking device 208 can be compared with the position reference database 108 to provide an orientation of the boresight axis T_{B} relative to the geodetic coordinates 210, and thus the orientation of the movable platform on which the optical tracking device 208 is included.

In the first view 202, the diagram 200 includes an initial reference axis RA1. The reference axis RA1 is demonstrated as angularly offset in three-dimensional space from the first axis X_{INS}, which can correspond to a forward axis of the INS 206, by a three-dimensional angle θ_{RA1} corresponding to the reference orientation of the reference axis RA1 relative to the physical axes of the INS 206 (e.g., relative to the forward axis X_{INS}). The reference axis RA1 and the boresight axis T_{B} can initially be intended to be collinear, such that the reference axis RA1 is intended to be aligned with the boresight axis T_{B} in three-dimensional space. Therefore, during normal navigation operation, the INS 206 can be configured to correlate the reference images obtained by the optical tracking device 208 to the coordinate frame based on the angle θ_{RA1} relative to the forward axis X_{INS}.

As described in greater detail above, certain conditions can cause an angular misalignment between the boresight axis T_{B} of the optical tracking device 208 and the reference axis. The reference axis RA1 is demonstrated in the first view 202 as angularly offset in three-dimensional space from the boresight axis TB by a three-dimensional misalignment angle Φ. Therefore, while the misalignment angle Φ can be small (e.g., a fraction of a degree), the misalignment angle Φ can still cause significant errors in determining the orientation of the movable platform based on the combined determination of orientation by both the INS 206 and the optical tracking device 208, as described above.

The alignment controller 110 can thus implement an alignment algorithm that includes comparing the reference axis RA1, thus corresponding to the orientation of the coordinate frame provided by the INS 206, with the orientation of the boresight axis T_{B} to determine the misalignment angle Φ. Upon determining the misalignment angle Φ, as demonstrated in the second view 204, the alignment controller 110 can implement the alignment algorithm to adjust an angular offset between the reference axis RA1 and the axis X_{INS} from the angle θ_{RA1} to an angle θ_{RA2}. Thus, the reference orientation of the initial reference axis RA1 is adjusted relative to the physical axes of the INS (e.g., by the misalignment angle Φ), thereby aligning an adjusted virtual reference axis RA2 to the physical boresight axis T_{B}. Therefore, as demonstrated in the second view 204, the change in the reference orientation from the angle θ_{RA1} to an angle θ_{RA2} provides the adjusted reference axis RA2 that is aligned with the physical orientation defined by the boresight axis T_{B}, demonstrated as a collinear axis “T_{B}, RA2”. Accordingly, the alignment controller 110 can mitigate errors in the determination of the orientation of the movable platform, as provided by both the INS 206 and the optical tracking device 208, relative to the geodetic coordinates 210.

As an example, the alignment algorithm can be configured to implement vector matrix calculations to determine the misalignment angle Φ and to adjust the coordinate frame of the INS 206 to align the reference axis RA to the boresight axis T_{B}. For example, the orientation of the coordinate frame of the INS 206 with respect to the Earth geodetic frame can be expressed by the following matrix transformation:

$${C}_{B}^{G} = \qquad Equation 1$$

$$[ \begin{matrix}cos Ψ cos ϕ & - sin Ψ cos θ + cos Ψ sin ϕ sin θ & sin Ψ sin θ + cos Ψ sin ϕ cos θ \\ sin Ψ cos ϕ & cos Ψ cos θ + sin Ψ sin ϕ sin θ & - cos Ψ sin θ + sin Ψ sin ϕ cos θ \\ - sin ϕ & cos ϕ sin θ & cos ϕ cos θ\end{matrix} ]$$

Where: Ψ is a True Heading of the INS 206, and can thus correspond to the reference axis RA, as demonstrated in the example of FIG. 2;
Φ is a Pitch of the INS 206; and
θ is a Roll of the INS 206.
   The alignment controller 110 can thus generate a body axis unit vector corresponding to the reference axis RA in the Earth geodetic frame based on Equation 1, as follows:

$${\vec{u}}_{B}^{( G )} = {C}_{B}^{G} [ \begin{matrix}1 \\ 0 \\ 0\end{matrix} ] = [ \begin{matrix}cos Ψ cos ϕ \\ sin Ψ cos ϕ \\ - sin ϕ\end{matrix} ] \qquad Equation 2$$

The alignment controller 110 can also provide a transformation from the boresight axis T_{B} to the Earth geodetic frame. Because orientation about the boresight axis T_{B} is initially unknown, the transformation boresight axis T_{B} to the Earth geodetic frame can include only azimuth and elevation, and can be expressed by the unit vector in the direction of the boresight axis T_{B} as follows:

$${\vec{u}}_{T}^{( G )} = [ \begin{matrix}cos Az & - sin Az & 0 \\ sin Az & cos Az & 0 \\ 0 & 0 & 1\end{matrix} ] [ \begin{matrix}cos E & 0 & sin E \\ 0 & 1 & 0 \\ - sin E & 0 & cos E\end{matrix} ] [ \begin{matrix}1 \\ 0 \\ 0\end{matrix} ] = \qquad Equation 3$$

$$[ \begin{matrix}cos Az cos E \\ sin Az cos E \\ - sin E\end{matrix} ]$$

Where:Az is the azimuth angle relative to North; and
E is the elevation angle relative to a local level plane.
   The alignment controller 110 can implement a cross-product of the unit vectors \vec{u}_{B}^{(G)} and \vec{u}_{T}^{(G)} to define an axis of rotation for the misalignment angle Φ, expressed in the Earth geodetic frame as follows:

Φ^{(G)}=\vec{u}_{B}^{(G)}×\vec{u}_{T}^{(G)} Equation 4

The unit vector in the rotation direction from the reference axis RA to the boresight axis T_{B} can therefore be expressed as a division of the vector cross-products by its magnitude, as follows:

$${\vec{u}}_{Φ}^{( G )} = \frac{{\vec{u}}_{B}^{( G )} \times {\vec{u}}_{T}^{( G )}}{‖ {\vec{u}}_{B}^{( G )} \times {\vec{u}}_{T}^{( G )} ‖} \qquad Equation 5$$

From Equation 5, the misalignment angle Φ can be calculated based on calculating an inverse tangent of the magnitude of the vector cross product of the reference axis RA unit vector and the boresight axis T_{B} unit vector over a vector dot product of the reference axis RA unit vector and the boresight axis T_{B}, as follows:

$$Φ = {tan}^{- 1} ( \frac{‖ {\vec{u}}_{B}^{( G )} \times {\vec{u}}_{T}^{( G )} ‖}{{\vec{u}}_{B}^{( G )} \cdot {\vec{u}}_{T}^{( G )}} ) \qquad Equation 6$$

Upon determining the misalignment angle Φ, the alignment controller 110 can be configured to adjust the coordinate frame of the INS 206 to align the reference axis RA with the boresight axis T_{B}. The alignment controller 110 can convert the unit vector of the misalignment rotation \vec{u}_{Φ}^{(G)} to the body coordinates of the INS 206 by transforming through a transpose, expressed as C_{G}^{B}, of the orientation C_{B}^{G} of the coordinate frame of the INS 206 provided in Equation 1, as follows:

\vec{u}_{Φ}^{(B)}=C_{G}^{B}\vec{u}_{Φ}^{(G)} Equation 7

As an example, the alignment controller 110 can implement Rodriquez' rotation equation to form a rotation matrix from the coordinate frame of the INS 206 to the boresight axis T_{B}, thus corresponding to a boresight correction matrix. The boresight correction matrix can be expressed as follows:

C_{B}^{T}=I+sin Φ[\vec{u}_{Φ}^{(B)}x]+(1−cos Φ)[\vec{u}_{Φ}^{(B)}x]² Equation 8
Where:I is the identity matrix; and
[\vec{u}x] is the skew symmetric matrix.
   The skew symmetric matrix [\vec{u}x] can be expressed as follows:

$$[ \vec{u} x ] = [ \begin{matrix}0 & - {u}_{z} & {u}_{y} \\ {u}_{z} & 0 & - {u}_{x} \\ - {u}_{y} & {u}_{x} & 0\end{matrix} ] \qquad Equation 9$$

By using the boresight correction matrix C_{B}^{T} of Equation 8, the alignment controller 110 can resolve the attitude of the INS 206 to the boresight axis T_{B} by implementing the coordinate frame matrix C_{B}^{G} and a transpose of the boresight correction matrix, as follows:

C_{T}^{G}=C_{B}^{G}C_{T}^{B} Equation 10

The alignment controller 110 can thus extract corrected roll, pitch, and true heading (e.g., reference axis RA) from the matrix C_{T}^{G} of Equation 10. The alignment controller 110 can thus save the corrected roll, pitch, and true heading to the memory 104 as the updated reference orientation (e.g., the three-dimensional angle θ_{RA2}). The alignment controller 110 can also store the transformation C_{B}^{T} in memory 104 for future use when initializing the INS 206, such that the INS 206 can define the reference axis RA based on the three-dimensional angle θ_{RA2} stored in the memory 104 to align the reference axis RA to the boresight axis T_{B} at initialization. As a result, the alignment controller 110 can mitigate errors resulting from the misalignment angle Φ between the reference axis RA of the coordinate frame of the INS 206 and the boresight axis T_{B} of the optical tracking device 208.

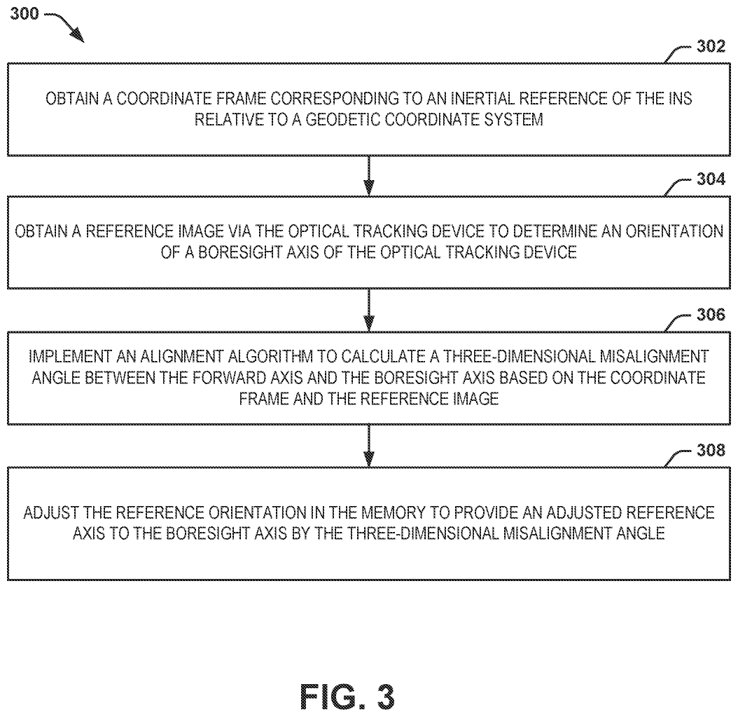

In view of the foregoing structural and functional features described above, an example method will be better appreciated with reference to FIG. 3. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured in an integrated circuit, processor, or a controller, for example.

FIG. 3 illustrates an example of a method 300 for aligning a boresight axis (e.g., the boresight axis T_{B}) of an optical tracking device (e.g., the optical tracking device 106) with a coordinate frame of an INS (e.g., the INS 102). At 302, a coordinate frame corresponding to an inertial reference of the INS is obtained. The coordinate frame includes a reference axis (e.g., the reference axis RA1) having a reference orientation relative to physical axes of the INS. At 304, a reference image is obtained via the optical tracking device to determine an orientation of the boresight axis of the optical tracking device. At 306, an alignment algorithm is implemented to calculate a three-dimensional misalignment angle (e.g., the misalignment angle Φ) between the reference axis and the boresight axis based on the coordinate frame and the reference image. At 308, the reference orientation is adjusted in the memory to provide an adjusted reference axis (e.g., the reference axis RA2) to the boresight axis by the three-dimensional misalignment angle.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A navigation system comprising:
an inertial navigation system (INS) that is configured to provide a coordinate frame corresponding to an inertial reference of the INS relative to a geodetic coordinate system, the coordinate frame comprising a reference axis having a reference orientation relative to physical axes of the INS;
an optical tracking device configured to obtain a reference image to determine an orientation of a boresight axis of the optical tracking device; and
an alignment controller configured to compare the reference axis based on the coordinate frame and the boresight axis based on the reference image to determine a three-dimensional angular misalignment between the reference axis and the boresight axis, and to adjust the reference orientation to provide an adjusted reference axis that is aligned with the boresight axis based on the determined three-dimensional angular misalignment.

2. The system of claim 1, wherein the reference orientation is saved in a memory, wherein the alignment controller is configured to adjust the reference orientation in the memory to provide the adjusted reference axis aligned with the boresight axis.

3. The system of claim 1, wherein the alignment controller is configured to implement an alignment algorithm to calculate a three-dimensional misalignment angle between the reference axis and the boresight axis, wherein the alignment controller is configured to adjust the reference orientation by the three-dimensional misalignment angle to provide the adjusted reference axis.

4. The system of claim 3, wherein the alignment algorithm comprises defining the reference axis as a reference axis unit vector and the boresight axis as a boresight axis unit vector, calculating a vector cross product of the reference axis and boresight axis unit vectors to determine an axis of rotation of the three-dimensional misalignment angle, and calculating the three-dimensional misalignment angle based on the axis of rotation of the three-dimensional misalignment angle.

5. The system of claim 4, wherein the calculating the three-dimensional misalignment angle comprises calculating an inverse tangent of the magnitude of the vector cross product of the reference axis and boresight axis unit vectors over a vector dot product of the reference axis and boresight axis unit vectors.

6. The system of claim 4, wherein the alignment algorithm further comprises determining a unit vector of the axis of rotation based on the vector cross product, wherein the alignment algorithm further comprises converting the unit vector of the axis of rotation of the three-dimensional misalignment angle to the coordinate frame.

7. The system of claim 3, wherein the alignment algorithm further comprises converting the three-dimensional misalignment angle to the coordinate frame through vector matrix calculations.

8. The system of claim 1, wherein the optical tracking device is configured to obtain a plurality of reference images to determine the orientation of the boresight axis based on an aggregation of the plurality of reference images.

9. A movable platform comprising the navigation system of claim 1.

10. A method for aligning a boresight axis of an optical tracking device with a coordinate frame of an inertial navigation system (INS), the method comprising:
obtaining a coordinate frame corresponding to an inertial reference of the INS relative to a geodetic coordinate system, the coordinate frame comprising a reference axis having a reference orientation relative to physical axes of the INS;
obtaining a reference image via the optical tracking device to determine an orientation of a boresight axis of the optical tracking device;
implementing an alignment algorithm to calculate a three-dimensional misalignment angle between the reference axis and the boresight axis based on the coordinate frame and the reference image; and
adjusting the reference orientation in the memory to provide an adjusted reference axis to the boresight axis by the three-dimensional misalignment angle.

11. The method of claim 10, wherein implementing the alignment algorithm comprises:
defining the reference axis as a reference axis unit vector and the boresight axis as a boresight axis unit vector;
calculating a vector cross product of the reference axis and boresight axis unit vectors to determine an axis of rotation of the three-dimensional misalignment angle; and
calculating the three-dimensional misalignment angle based on the axis of rotation of the three-dimensional misalignment angle.

12. The method of claim 11, wherein the calculating the three-dimensional misalignment angle comprises calculating an inverse tangent of the magnitude of the vector cross product of the reference axis and boresight axis unit vectors over a vector dot product of the reference axis and boresight axis unit vectors.

13. The method of claim 11, wherein implementing the alignment algorithm further comprises:
determining a unit vector of the axis of rotation based on the vector cross product; and
converting the unit vector of the axis of rotation of the three-dimensional misalignment angle to the coordinate frame.

14. The method of claim 10, wherein obtaining the reference image comprises obtaining a plurality of reference images via the optical tracking device to determine the orientation of the boresight axis based on an aggregation of the plurality of reference images.

15. The method of claim 10, further comprising:
storing the reference orientation in the memory; and
accessing the memory to obtain the reference orientation to provide the adjusted reference axis aligned with the boresight axis at initialization of the INS.

16. A navigation system comprising:
an inertial navigation system (INS) that is configured to provide a coordinate frame corresponding to an inertial reference of the INS relative to a geodetic coordinate system, the coordinate frame comprising a reference axis having a reference orientation relative to physical axes of the INS;
an optical tracking device configured to obtain a reference image to determine an orientation of a boresight axis of the optical tracking device; and
an alignment controller configured to compare the reference axis based on the coordinate frame and the boresight axis based on the reference image to calculate a three-dimensional misalignment angle between the reference axis and the boresight axis, the alignment controller being further configured to implement vector matrix calculations to convert the three-dimensional misalignment angle to a coordinate frame transformation and to adjust the reference orientation by the three-dimensional misalignment angle to provide an adjusted reference axis that is aligned with the boresight axis.

17. The system of claim 16, wherein the reference orientation is saved in a memory, wherein the alignment controller is configured to adjust the reference orientation in the memory to provide the adjusted reference axis aligned with the boresight axis.

18. The system of claim 17, wherein the alignment algorithm comprises defining the reference axis as a reference axis unit vector and the boresight axis as a boresight axis unit vector, calculating a vector cross product of the reference axis and boresight axis unit vectors to determine an axis of rotation of the three-dimensional misalignment angle, and calculating the three-dimensional misalignment angle based on the axis of rotation of the three-dimensional misalignment angle.

19. The system of claim 18, wherein the calculating the three-dimensional misalignment angle comprises calculating an inverse tangent of the magnitude of the vector cross product of the reference axis and boresight axis unit vectors over a vector dot product of the reference axis and boresight axis unit vectors.

20. The system of claim 18, wherein the alignment algorithm further comprises determining a unit vector of the axis of rotation based on the vector cross product, wherein the alignment algorithm further comprises converting the unit vector of the axis of rotation of the three-dimensional misalignment angle to the coordinate frame.
